(19) United States
(12) Patent Application Publication
(10) Pub. No.: US 2005/0272330 A1
(43) Pub. Date: Dec. 8, 2005

(54) Method for embedding a distinguishing aesthetic and/or functional surface feature into a panel surface

(76) Inventors: John D. Gray, Union, NH (US); Robert Booth, Venice, FL (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/861,903

(22) Filed: Jun. 4, 2004

(51) Int. Cl. B32B 27/04; B32B 27/12; B32B 3/26; B32B 18/00; B32B 31/12

(52) U.S. Cl. 442/38; 442/2; 442/6

(57) ABSTRACT

A method for embedding a distinguishing aesthetic and/or functional surface feature into a panel surface is described. An open mesh sheet of material is applied to a mold surface and plastic applied to the mold surface and to the back side of the open mesh material. The plastic forms a shell that is then removed from the mold with the open mesh material at least partially embedded in the surface of the shell. The shell then may be used as a trim panel that includes the aesthetic and functional features of the open mesh material.

### TECHNICAL FIELD OF THE INVENTION

This invention relates generally to molding and, more particularly, to a method for embedding a distinguishing appearance and/or functional surface feature into the surface of a molded panel.

### BACKGROUND OF THE INVENTION

It is known for panels to include embedded color features that have outer surfaces that lie flush with outer surfaces of the panels they are embedded in. One current process for producing such products includes forming a feature on a slush mold surface, then casting a charge of powdered plastic against the mold and a back surface of the color feature.

One example of this process is disclosed in U.S. Pat. No. 5,648,030 issued Jul. 15, 1997 to Pemberton et al. According to Pemberton et al., the color feature is formed by first placing a stencil on the mold surface then casting a plastic powder into the stencil. The stencil is then removed before the second charge of plastic is cast. The formation of the feature on the mold ties up molds for an excessive period of time and is labor intensive. In addition, to accurately cast plastic powder exclusively into the confines of a stencil on a mold surface requires additional tooling and/or labor to prevent the powder from falling onto other portions of the mold.

Methods for applying pre-formed features in panel surfaces are disclosed in U.S. Pat. Nos. 4,519,972 and 5,498,307 issued to Stephenson. The Stevenson '307 patent disclosed a rotomolding process that includes affixing features to mold surfaces using an adhesive. In the Stevenson '972 patent, features are affixed by burnishing.

U.S. Pat. No. 3,207,822 to American Can Co., entitled “Method of Decorating Plastic Objects” is directed at a process of manufacturing a plastic bottle with a label on the surface thereof, wherein the mold has a portion of its sizing coarsely roughened and the label is overlayed in this roughened portion. This is followed by inflating a parison inside the mold and against the label.

U.S. Pat. No. 3,349,158 to Pandora Custom Craft, entitled “Method and Apparatus for Making Mosaics” is directed at a method of making a composite mosaic-like structure from a plurality of flat blocks of irregular shape arranged by hand in a frame, and adhesively securing a flexible sheet to secure the blocks. This is followed by introducing a flowable resinous bonding material to the backside of the sheet and blocks which hardens to form the mosaic.

U.S. Pat. No. RE 28,068 by Jerome H. Lemelson, entitled “Article Decoration Apparatus and Method” is directed at a series of methods and corresponding apparatuses to selectively deposit a first material against a mold surface and integrating the first material during the shaping operation of the molded article. Independent claims are directed at spraying a fluent material on the mold surface and molding behind it, using an electrostatic charge to selectively attract particles of the decorating material to portions of the mold wall, bonding said decorative material to the mold cavity, heating a selected area of the mold to form a molten coating on said selected area, using an intense electron beam to cause a first material to form a coating on the mold surface, bonding a first article to the mold surface by directing an intense radiation beam thereagainst, disposing a mask having openings through which droplets or particles are sprayed and charging those droplets with the same polarity as the mask is charged, using a mold having a plurality of raised portions and heating those portions such that molten thermoplastic is deposited thereupon, electrostatic deposition means for transferring a fluent material, and applying a quantity of particulate thermoplastic material to a substrate and non-uniformly applying heat by generating and directing radiant energy in a selected pattern from above said substrate to melt and fuse said material to selected areas of said substrate.

U.S. Pat. No. 3,839,129 to Pictorial Productions, Inc., entitled “Reflective Foil and Process” is directed at an injection molded thermoplastic article comprising a smooth foil, said foil comprising a substrate layer made integral during injection molding the article, a clear and protective layer bonded to the substrate and a smooth and bright metallized layer disposed between the protective layer and the substrate.

U.S. Pat. No. 4,894,004 to Davidson Textron, Inc., entitled “Apparatus for Molding Multi-Colored Plastic Shells” is directed at a mold and powder box assembly wherein the mold includes a casting surface having a plurality of alternate raised surfaces and recesses and the powder box includes spaced dams which align the dams to the recesses in the mold. A first thin layer is cast of a certain color and fused. Subsequently, the skin layer covering the raised portion of the mold is removed and additional color(s) may be selectively cast onto those raised mold surfaces to form the multi-colored shell.

U.S. Pat. No. 5,073,325 also to Davidson Textron, Inc., entitled “Method for Producing A Molded Article Having Stabilized Decorative Features” is directed at a casting process whereby the mold contains a recessed surface corresponding to a desired surface feature and the recessed surface is selectively heated to partially fuse a first plastic material only in the recessed areas. Subsequently, a plastisol is sprayed over the remaining first material to stabilize its location and fused. Finally, a second thermoplastic material is cast behind the first material and plastisol layer to form the shell with decorative features thereon.

U.S. Pat. No. 5,604,006 to Cascade Engineering, entitled “Label Inmolding Process and Article of Manufacture Produced Therefrom” is directed at a process for producing a label-bearing article comprising the steps of adhesively mounting a label to the first side of a thin plastic substrate, placing that substrate into the cavity of an injection mold and injecting a molten thermoplastic resin under heat and pressure, the heat and pressure being sufficient to at least partially recess the label into the first side of the thin plastic substrate.

U.S. Pat. No. 5,693,277 to Michael R. Widmer, entitled “Method for Making a Novelty Candle” is directed at forming a sheet of wax, cutting a plurality of different defined shapes from that sheet of wax, arranging the plurality of different defined shapes in a mold to stand alongside and flush with the flat side wall of the mold, partially filling the interior of the mold with additional wax pieces to hold the different defined shapes in place and filling the remainder of the mold with liquid wax.

In JP-62-018229A2 to Kojima Press Co., Ltd., entitled “Manufacture of Resin-Molded Product”, a process is disclosed to mold a distinguished partition on the border portion between the resins with different color tones whereby thermoplastic resin sheets having an arbitrary specified shape and a plurality of fine through-holes are positioned closely in contact on the mold surface of a heated mold and “the air intervening between the resin sheets and the mold surface is perfectly drawn away through the fine holes of the sheets”. (Constitution). Consequently, the sheets are stuck to the mold surface and a different colored resin is expanded onto the surface of the mold and fused. This invention would not seem suitable for discontinuous features (mesh) as in the present invention.

Finally, WO 01/81062 (TRM DV 2602), entitled “Method for Embedding a Colored Feature into a Panel Surface”, now abandoned, was directed at providing a first preformed feature on a mold surface, causing the preformed feature to adhere to the mold surface by heating the mold surface, and applying plastic material against the remaining mold surface and a back surface of the preformed feature. This reference does not teach or suggest casting a plastic powder behind an open weave pliable sheet or preform which has been applied to an open mold surface.

What is needed is simple, quick, inexpensive and non-labor intensive process for embedding a distinguishing appearance and/or functional surface feature into the surface of a molded panel.

### SUMMARY OF THE INVENTION

In accordance with this invention, a process is provided for embedding a distinguishing appearance and/or functional surface feature into a surface of a plastic shell, preferably for an automotive trim panel, wherein the feature is made from a pliable open mesh sheet of preferably plastic material which is placed onto a mold surface before casting or forming the plastic shell. A mold comprises a mold surface having a shape complementing a desired shape of the surface of the plastic shell to be molded. A pliable open mesh sheet, preferably of plastic material, is placed onto the heated mold surface and generally conforms to the mold surface due to the compositional nature of the sheet or by other means. A quantity of plastic, in liquid, particulate or melt form is then applied against the mold surface and the back surface of the open mesh sheet of preferably plastic material. This causes the open mesh sheet to further conform to the mold surface but also allows the liquid, powder or polymer melt to at least partially penetrate the interstices of the open mesh. The resulting composite shell including a distinguishing appearance feature is then cooled and removed from the mold surface with the distinguishing appearance feature embedded in the surface of the shell. Designs formed on shell surfaces in this way are durable in that they are not as susceptible to being worn off as are surface coatings such as paint. Because the design is embedded in the shell, colors and/or color shades that distinguish the feature from the surrounding shell surface are more likely to last the lifetime of the shell. An embedded feature produced by the inventive process is distinguishable from the surrounding shell surface not only by visual differences such as color or shade and pattern, therefore providing more design freedom for the stylist, but also the by the nature of the surface (e.g. non-skid) of the open mesh sheet. This may further provide a similar condition, or property, to the surface of the finished plastic shell as the outer surface of the open mesh sheet is at least partially exposed, generally at the intersections of the mesh pattern.

Thus, according to another aspect of the invention, the open mesh sheet of preferably plastic material has a surface condition or property that is the different from the surface condition or property of the plastic that is cast or applied against the mold to form the main body of the plastic shell. By using the open mesh material to form a portion of the surface of the plastic skin or shell, the specific property (e.g. non-skid nature, high friction, gripping) may be transferred to or included in the shell material and provide a unique property as well as unique appearance within the shell.

According to another aspect of the invention, a plurality of features of an open mesh material are provided, with the plurality of features being shaped to form a composite design in a predetermined pattern which appear in the surface of a cast or formed plastic shell or skin. The plurality of features are then located in predetermined positions on the mold surface in the predetermined pattern to form the composite aesthetic design. The plurality of features generally conforms to the mold surface due to the composition nature of the sheet of open mesh material or other means. A charge of liquid, particulate or molten plastic is applied against the back surface of the respective features and against the mold surface which has been further heated to processing temperature. The resulting shell or skin is then cooled and stripped from the mold surface with the plurality of features being embedded in the surface of the shell in positions forming the composite design. Thus, the plurality of features may at least partially lie on the surface of the shell or skin and impart the aesthetic and functional aspects of these features to the shell. The resulting product may then be used in an application, say a console or tray area of a vehicle, and provide a distinguishing appearance as well as to impart an anti-skid property, for instance, to that area of the product that contains the embedded feature.

### BRIEF DESCRIPTION OF THE DRAWINGS

To better understand and appreciate the invention, refer to the following detailed description in connection with the accompanying drawings:

FIGS. 1-4 are alternate open mesh sheets of material which display a range of appearances which may be embedded to provide features to a shell surface in accordance with the inventive process.

FIG. 5 is a top view of the open mesh material of FIG. 4 embedded into the surface of a cast plastic shell, illustrating a distinguishing appearance feature imparted to the shell in accordance with the inventive process.

FIG. 6 is a partial cross-sectional view of the shell of FIG. 5 illustrating one placement of the open weave sheet of FIG. 4 in accordance with the inventive process.

### DESCRIPTION OF THE INVENTION

Various products and, in particular automobiles, are sold based primarily upon distinguishing appearance features. Vehicle interiors are built with different levels of trim depending on the market segment for which the vehicle is being marketed. The present invention is directed at a method of incorporating a distinguishing aesthetic appearance in the surface of an interior trim panel for a vehicle which may also include the incorporation of a specific surface property. This property may be, for instance, one of high friction or anti-skid in order that items resting on the surface do not slide around during operation of the vehicle. In other instances, the property may be tactile, such as smoothness, roughness or softness, as with the incorporation of a fabric. In still other instances, the property may be more visual such as metallic-appearing or reflective.

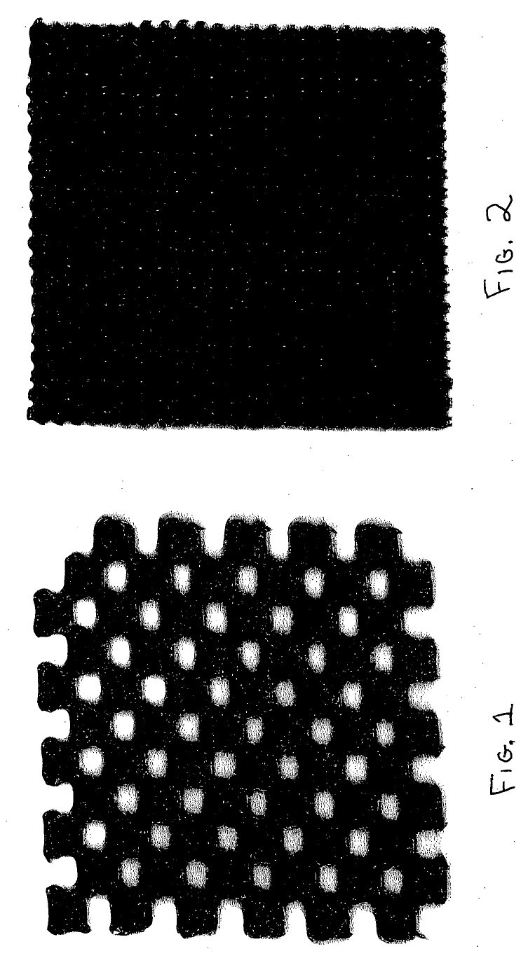

FIGS. 1-4 illustrate four different levels of an anti-skid grip liner or shelf liner as examples of open mesh material that may be partially embedded in the surface of a trim panel skin or shell for use in an automobile. By partially embedding a section of one of these open mesh or net-like materials into the surface of a preferably cast plastic skin, an area of the shell or panel can be provided having a distinguishing appearance in contrast to the adjacent or surrounding area. Further, an area of high friction or anti-skid may be provided as portions of the open mesh material remain at the surface of the shell. This frictional property is most useful on flat or recessed surfaces, such as armrest or console lids or in storage trays in console bases or in cargo areas to prevent items from sliding. An alternate use may be found as an insert in seat cover surfaces, particularly of vinyl or “artificial” leather which are naturally quite slick.

The materials illustrated in FIGS. 1-4 are typically called grip liners or shelf liners, such as provided by CONTACT Brand or NSW Co. and may comprise foamed PVC (polyvinyl chloride) which encapsulates a weave of fibers to provide an open mesh or network structure. The grip liners are particularly useful as anti-skid surfaces in the home. FIG. 1 illustrates an open mesh of about ¼″×¼″ spacing while FIGS. 2 and 3 illustrate a much tighter mesh. FIG. 4 illustrates an open mesh but having “nodes” of a more oval shape than the square nodes of FIG. 1. The open mesh sheet 10 comprises nodes 30 which are interconnected and separated by open spaces 50.

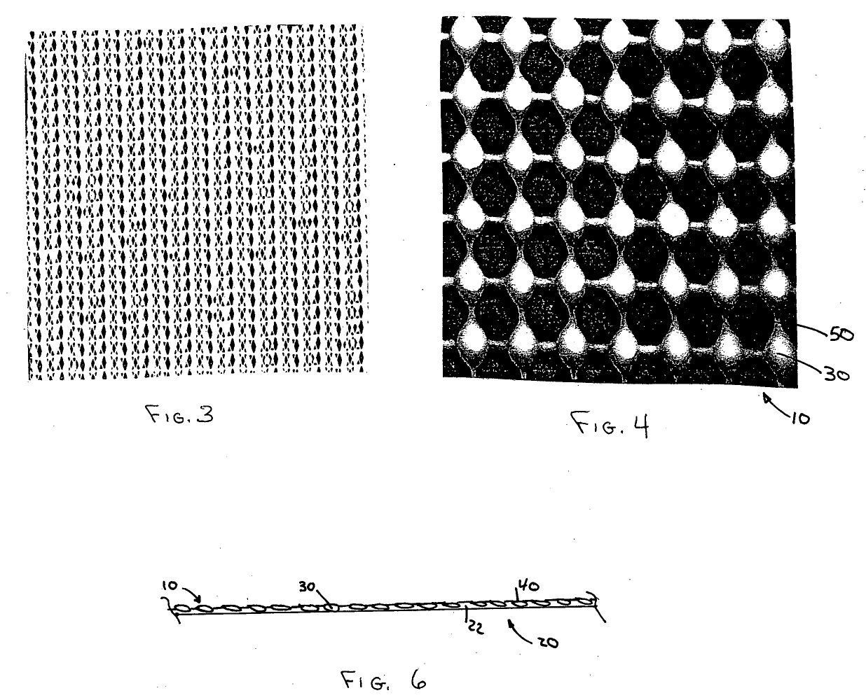

FIG. 5 illustrates the appearance of the sheet of open mesh material of FIG. 4 after it has been partially embedded in a PVC shell by casting and fusing. A unique appearance having a starburst nature resulted with primarily the nodes of the mesh visible at the surface of the shell. The presence of the open mesh foam material at the surface of the cast shell transfers the anti-skid or gripping property to that area of the surface of the cast PVC shell.

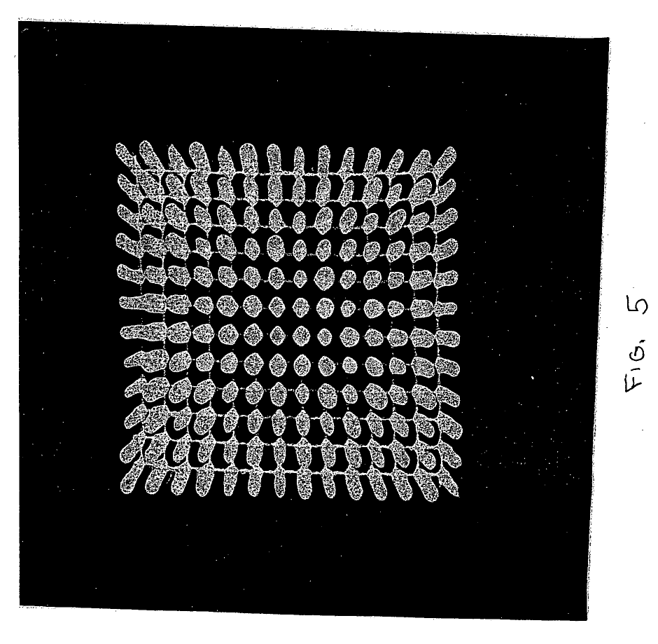

FIG. 6 is a cross-sectional view of FIG. 5 illustrating how the open mesh sheet 10 may be embedded in a plastic shell 20. The nodes 30 of the mesh are partially surrounded by or embedded in the plastic 22 as the shell 20 is being formed so that at least some of the mesh material 10 is visible and resides at the top surface 40 of the shell 20.

While a PVC foam open mesh material, such as grip liner, is described herein, other preferably open mesh, weave, net or networked materials may also provide unique appearance and functional properties to a portion of or the entire surface of a trim panel, including but not limited to cloth, fabric, metal, plastic and combinations thereof.

The present invention provides a distinguishing appearance and/or functional property to the surface of a preferably plastic product particularly a trim panel for, say, the interior of a vehicle. These trim panels may be of a fairly soft or rigid plastic, including but not limited to polyvinyl chloride (PVC), acrylonitrile-butadiene-styrene (ABS), polycarbonate (PC), thermoplastic olefin (TPO), thermoplastic elastomer (TPE) thermoplastic rubber (TPR), polyurethane (PU) polyimide, nylon, polyethylene, polypropylene, and blends combinations and alloys thereof.

A wide variety of processes may be used to form these panels or shells or skins that may form the outer layers of trim panels, including but not limited to, slush molding, casting, rotational molding, blow molding, transfer molding, injection molding, compression molding, vacuum forming, spray coating, low pressure molding, reaction injection molding and combinations thereof.

Lower pressure processes (“gravity” molding) which involve less shearing of the polymer during mold filling are preferred such that the open mesh material retains its position and shape during embedding.

In one particular embodiment, the PVC foam mesh illustrated in FIG. 4 was placed onto the heated surface of a nickel electroformed mold in a specific area to be decorated. The mesh sheet retained its position on the mold surface due to the high friction imparted by the gripping nature of the sheet. A PVC drysol compound, such as described in U.S. Pat. Nos. 6,410,141; 5,998,030; 5,654,102; 5,525,284; 5,525,274; and U.S. application Publication No. 2004/0054085 assigned to the assignee of the present invention and included herein by reference, was cast onto the backside of the open mesh sheet and onto the remaining mold surface to embed the open mesh sheet. Upon fusing the PVC drysol compound, and cooling and removing the resultant shell from the mold, an area having the appearance illustrated in FIG. 5 was obtained.

Thus, the preferred molding process includes the applying, preferably by casting, of a charge of the plastic shell material, preferably thermoplastic in powder or microsphere form, against the mold and against the back surface of the sheet of mesh material. The mold surface may be heated to molding temperature either before or after applying the charge of plastic shell material against the mold surface. At the molding temperature, the mold transfers sufficient heat energy to the plastic shell material 22 to at least partially melt the particles of plastic shell material 22 to the point where they bond together to form a shell 20. The resulting shell 20 is then cooled and removed from the mold surface with the open mesh feature 30 at least partially embedded in the surface of the shell 20 and visible on an outer surface 40 of the shell 20 as shown in FIG. 6. Any suitable molding process may be used to form the shell 20 around the open mesh material including the processes disclosed in U.S. Pat. Nos. 4,882,173; 4,895,690; 4,983,906 and 5,072,325 which are assigned to the assignee of the present invention and are incorporated herein by reference. In addition, blow molding provides an alternative low pressure, low shear molding process for decorating a surface with an open mesh material as illustrated herein

Other embodiments may include the provision of an open mesh material that is formed to include a layer of heat activatable adhesive. In this case, the open mesh is placed on the mold surface with the heat activatable adhesive layer at least partially contacting the mold surface. It may or may not be necessary to heat the mold to molding temperature to activate the adhesive layer.

Rather than providing only a single feature, a plurality of preformed features may be provided with the sheet of open mesh material. The plurality of features may differ from one another in optically discernible characteristics such as shading and coloring or by pattern or texture.

Further, the plurality of features may be shaped to form a composite pattern in the form of an image, a textual message, a design or the like, when the features are in a predetermined array.

While powder casting is a preferred process for producing the shell or trim panel of the present invention, liquid casting is also possible (plastisol, for instance). Further, spray application of either a liquid or powder behind the open mesh material and onto the mold surface may be performed.

Other means to locate the open mesh material on the mold surface may include, but are not limited to, mechanical, adhesive, magnetic, melting and combinations thereof.

In one particular embodiment, the surface of the mold is provided with a pattern of recesses that match the open mesh pattern of the sheet of material to be embedded, such that the nodes are at least partially engaged in the recesses in the mold surface to provide general registration and ensure that the open mesh material is located at the surface of the trim panel and only partially embedded.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific-embodiments disclosed, and that modifications to the disclosed embodiments, as well as other embodiments, are intended to be included within the scope of the appended claims. The invention is defined by the following claims, with equivalents of the claims to be included therein.

1. A process for embedding a mesh sheet of material into a surface of a plastic shell made from plastic material applied against a mold; the process comprising:
providing a mold comprising a mold surface having a shape complementing the surface of the plastic shell;
providing an open mesh sheet of material having a front surface and a back surface;
applying the front surface of the open mesh sheet of material to at least partially contact the mold surface;
applying plastic material against the remaining mold surface and the back surface of the open mesh material;
and removing the resulting shell from the mold surface with the open mesh material at least partially embedded in the surface of the shell.

2. The process as set forth in claim 1 in which the step of heating the mold surface is performed before depositing the plastic material on the mold surface.

3. The process as set forth in claim 1, wherein the plastic material comprises a particulate.

4. The process as set forth in claim 1, wherein the plastic material is a liquid.

5. The process as set forth in claim 1, wherein the plastic material is a polymer melt.

6. The process set forth in claim 1, wherein the step of providing the open mesh sheet of material includes a layer of heat activated adhesive; and the open mesh sheet is deposited on the mold surface with the heat activated adhesive layer at least partially contacting the mold surface.

7. The process as set forth in claim 1, wherein the step of providing the open mesh sheet of material includes forming the sheet by die cutting.

8. The process as set forth in claim 1, wherein the open mesh sheet comprises grip liners.

9. A process for embedding a feature into a surface of a plastic shell made from plastic material; the process comprising the steps of:
providing a mold comprising a mold surface having a shape complementing the surface of the plastic shell,
providing a plurality of open mesh materials having a back surface, the plurality of open mesh materials shaped to form a composite design;
depositing the plurality of open mesh materials in predetermined positions on the mold surface in a predetermined pattern forming the composite design;
causing the plurality of open mesh materials to conform to the mold surface;
applying a charge of plastic against the mold surface and the back surfaces of the respective open mesh materials; and
removing the resulting shell from the mold surface with the plurality of open mesh materials at least partially embedded in the surface of the shell.

10. A trim panel having aesthetic and functional surface features, comprising:
a plastic shell
an open mesh sheet of material at least partially embedded in the surface of the plastic shell.

11. The trim panel of claim 10, wherein the open mesh sheet is a plastic mesh.

12. The trim panel of claim 10, wherein the open mesh sheet is a fabric.

13. The trim panel of claim 10, wherein the open mesh sheet is a metal mesh.

14. The trim panel of claim 11, wherein the open mesh sheet is a grip liner.

15. The trim panel of claim 10, wherein the plastic shell provides the outer surface for a composite panel.
